(19) United States
(12) Patent Application Publication
(10) Pub. No.: US 2015/0025995 A1
(43) Pub. Date: Jan. 22, 2015

(54) GENERATING RECOMMENDATIONS BASED ON TRANSACTION DATA

(71) Applicants: Han-Shen Yuan, Sunnyvale, CA (US); Ron Gura, Tel-Aviv (IL); Matanya Bar, Tel-Aviv (IL); Erez Dickman, Tel-Aviv (IL)

(72) Inventors: Han-Shen Yuan, Sunnyvale, CA (US); Ron Gura, Tel-Aviv (IL); Matanya Bar, Tel-Aviv (IL); Erez Dickman, Tel-Aviv (IL)

(73) Assignee: eBay Inc., San Jose, CA (US)

(21) Appl. No.: 13/946,927

(22) Filed: Jul. 19, 2013

(51) Int. Cl. G06Q 30/06

(52) U.S. Cl. CPC G06Q 30/0631
USPC 705/26.7

(57) ABSTRACT

Systems and methods of generating recommendations based on transaction data are described. A first business entity may collect transaction data corresponding to a user from at least one external source. The transaction data may comprise at least one identification of an item purchased by the user, and the external source(s) may belong to a separate business entity from the first business entity and host an account of the user. A recommendation for the user may be generated based on the collected transaction data. In some embodiments, the recommendation may comprise a recommendation to buy an item or a recommendation to sell an item. The generated recommendation may also be based on transaction data corresponding to at least one other user.

### TECHNICAL FIELD

The present application relates generally to the technical field of data processing, and, in various embodiments, to systems and methods of generating recommendations based on transaction data.

### BACKGROUND

Currently, the ability of e-commerce sites to make quality recommendations to its users is limited. As a result, opportunities to increase user engagement, and thus revenue, are being lost.

### BRIEF DESCRIPTION OF THE DRAWINGS

Some embodiments of the present disclosure are illustrated by way of example and not limitation in the figures of the accompanying drawings, in which like reference numbers indicate similar elements, and in which:

FIG. 1 is a block diagram depicting a network architecture of a system having a client-server architecture configured for exchanging data over a network, in accordance with some embodiments;

FIG. 2 is a block diagram depicting various components of a network-based publication system, in accordance with some embodiments;

FIG. 3 is a block diagram depicting various tables that may be maintained within a database, in accordance with some embodiments;

FIG. 4 is a block diagram illustrating a recommendation system, in accordance with some embodiments;

FIG. 5 illustrates generated recommendations being displayed on a user interface of a computing device, in accordance with some embodiments;

FIG. 6 is a flowchart illustrating a method of generating a recommendation, in accordance with an example embodiment; and

FIG. 7 shows a diagrammatic representation of a machine in the example form of a computer system within which a set of instructions may be executed to cause the machine to perform any one or more of the methodologies discussed herein, in accordance with some embodiments.

### DETAILED DESCRIPTION

The description that follows includes illustrative systems, methods, techniques, instruction sequences, and computing machine program products that embody illustrative embodiments. In the following description, for purposes of explanation, numerous specific details are set forth in order to provide an understanding of various embodiments of the inventive subject matter. It will be evident, however, to those skilled in the art that embodiments of the inventive subject matter may be practiced without these specific details. In general, well-known instruction instances, protocols, structures, and techniques have not been shown in detail.

The present disclosure describes systems and methods of generating recommendations based on transaction data. This transaction data may be obtained from external sources, thereby expanding the amount of information that may be used in generating recommendations, and thus increasing the quality of the recommendations. For example, instead of a website merely using a user's behavioral history on the website, it may use information about purchases and sales that the user has made that have been independent of the website. This information may be retrieved from receipts sent to an e-mail address of the user, or from transaction records for an account of the user that is maintained by a business entity separate and independent from the website collecting the transaction data. In one example, a first e-commerce site may obtain transaction data corresponding to transactions the user has engaged in with other e-commerce sites or other retailers, and then use this transaction data to generate recommendations for the user. The website may additionally or alternatively use similarly obtained transaction data of other users to generate recommendations for the user.

In some embodiments, a system may comprise a machine, a transaction data collection module, and a recommendation generation module. The machine may have a memory and at least one processor. The transaction data collection module may be operated by a first business entity and be configured to collect transaction data corresponding to a user from at least one external source. The transaction data may comprise details of a commercial transaction engaged in by the user and may identify at least one item purchased by the user. The external source(s) may belong to a separate business entity from the first business entity and may host an account of the user. The recommendation generation module may be configured to generate a recommendation for the user based on the collected transaction data.

In some embodiments, the external source may be an e-mail service provider, and the transaction data collection module may be configured to collect the transaction data by parsing through e-mail communications belonging to the account of the user. In some embodiments, the e-mail communications may comprise at least one receipt for the purchased item. In some embodiments, the external source may be a retail service provider.

In some embodiments, the external source may be a social network service provider, and the transaction data collection module may be configured to collect the transaction data by parsing through communications belonging to the account of the user for the social network service provider. In some embodiments, the transaction data collection module may also collect social network data, such as a user posting a comment about a product or indicating an interest in a product (e.g., “liking” a product), which may then be used by the recommendation generation module to generate a recommendation for the user.

In some embodiments, the recommendation may comprise a recommendation to buy an item. In some embodiments, the recommendation may comprise a recommendation to sell an item. It is contemplated that other types of recommendations are also within the scope of the present disclosure, including, but not limited to, recommendations to consign, borrow, lend, and trade.

In some embodiments, the recommendation generation module may be further configured to provide the recommendation to the user. In some embodiments, the recommendation generation module may be configured to provide the recommendation to the user by transmitting an e-mail message comprising the recommendation to the user. In some embodiments, the recommendation generation module may be configured to provide the recommendation to the user by presenting the recommendation to the user on a website of the first business entity while the user is accessing the website on a device.

In some embodiments, the transaction data collection module may be further configured to collect other transaction data corresponding to at least one other user from at least one external source. The other transaction data may comprise at least one identification of an item purchased by the other user(s). The external source(s) may belong to a separate business entity from the first business entity and may host an account of the at least one other user. The recommendation generation module may be further configured to generate the recommendation for the user also based on the collected other transaction data corresponding to the other user(s).

In some embodiments, a computer-implemented method may comprise collecting, by a first business entity, transaction data corresponding to a user from at least one external source. The transaction data may comprise at least one identification of an item purchased by the user. The external source(s) may belong to a separate business entity from the first business entity and may host an account of the user. A recommendation may be generated for the user based on the collected transaction data.

In some embodiments, the external source may be an e-mail service provider, and collecting the transaction data may comprise parsing through e-mail communications belonging to the account of the user. In some embodiments, the external source may be a retail service provider.

In some embodiments, the recommendation may comprise a recommendation to buy an item. In some embodiments, the recommendation may comprise a recommendation to sell an item. It is contemplated that other types of recommendations are also within the scope of the present disclosure, including, but not limited to, recommendations to consign, borrow, lend, and trade.

In some embodiments, the method may further comprise providing the recommendation to the user. In some embodiments, providing the recommendation to the user may comprise transmitting an e-mail message comprising the recommendation to the user. In some embodiments, providing the recommendation to the user may comprise presenting the recommendation to the user on a website of the first business entity while the user is accessing the website on a device.

In some embodiments, the method may further comprise collecting, by the first business entity, other transaction data corresponding to at least one other user from at least one external source. The other transaction data may comprise at least one identification of an item purchased by the other user(s). The external source(s) may belong to a separate business entity from the first business entity and may host an account of the other user(s). The generated recommendation may also be based on the collected other transaction data corresponding to the other user(s).

In some embodiments, a non-transitory machine-readable storage device may store a set of instructions that, when executed by at least one processor, causes the at least one processor to perform the operations or method steps discussed within the present disclosure.

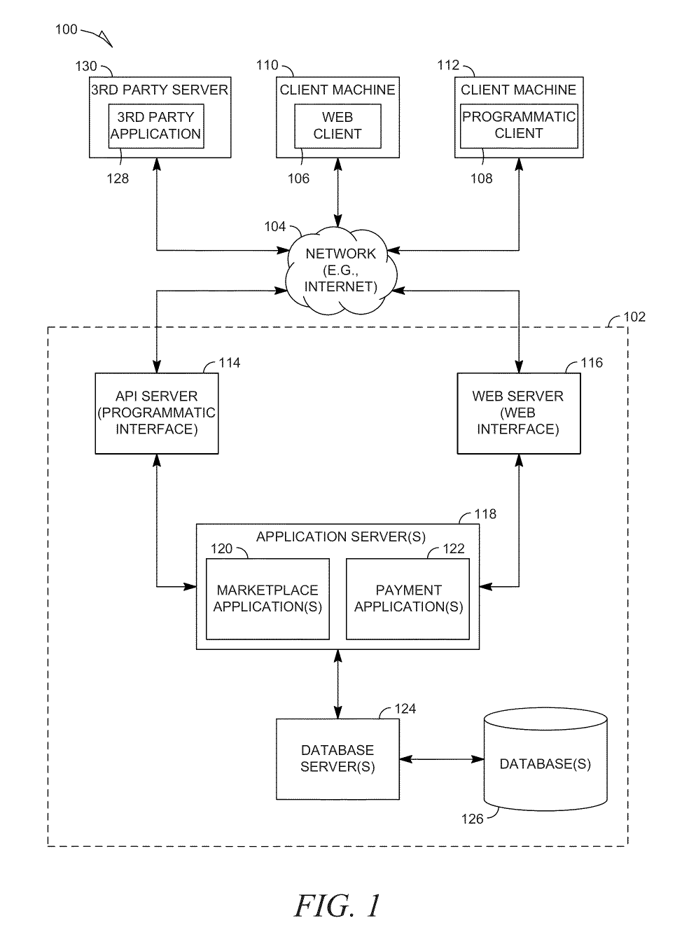

FIG. 1 is a network diagram depicting a client-server system 100, within which one example embodiment may be deployed. A networked system 102, in the example forms of a network-based marketplace or publication system, provides server-side functionality, via a network 104 (e.g., the Internet or a Wide Area Network (WAN)) to one or more clients. FIG. 1 illustrates, for example, a web client 106 (e.g., a browser, such as the Internet Explorer browser developed by Microsoft Corporation of Redmond, Wash. State) and a programmatic client 108 executing on respective client machines 110 and 112.

An API server 114 and a web server 116 are coupled to, and provide programmatic and web interfaces respectively to, one or more application servers 118. The application servers 118 host one or more marketplace applications 120 and payment applications 122. The application servers 118 are, in turn, shown to be coupled to one or more database servers 124 that facilitate access to one or more databases 126.

The marketplace applications 120 may provide a number of marketplace functions and services to users who access the networked system 102. The payment applications 122 may likewise provide a number of payment services and functions to users. The payment applications 122 may allow users to accumulate value (e.g., in a commercial currency, such as the U.S. dollar, or a proprietary currency, such as “points”) in accounts, and then later to redeem the accumulated value for products (e.g., goods or services) that are made available via the marketplace applications 120. While the marketplace and payment applications 120 and 122 are shown in FIG. 1 to both form part of the networked system 102, it will be appreciated that, in alternative embodiments, the payment applications 122 may form part of a payment service that is separate and distinct from the networked system 102.

Further, while the system 100 shown in FIG. 1 employs a client-server architecture, the embodiments are, of course not limited to such an architecture, and could equally well find application in a distributed, or peer-to-peer, architecture system, for example. The various marketplace and payment applications 120 and 122 could also be implemented as standalone software programs, which do not necessarily have networking capabilities.

The web client 106 accesses the various marketplace and payment applications 120 and 122 via the web interface supported by the web server 116. Similarly, the programmatic client 108 accesses the various services and functions provided by the marketplace and payment applications 120 and 122 via the programmatic interface provided by the API server 114. The programmatic client 108 may, for example, be a seller application (e.g., the TurboLister application developed by eBay Inc., of San Jose, Calif.) to enable sellers to author and manage listings on the networked system 102 in an off-line manner, and to perform batch-mode communications between the programmatic client 108 and the networked system 102.

FIG. 1 also illustrates a third party application 128, executing on a third party server machine 130, as having programmatic access to the networked system 102 via the programmatic interface provided by the API server 114. For example, the third party application 128 may, utilizing information retrieved from the networked system 102, support one or more features or functions on a website hosted by the third party. The third party website may, for example, provide one or more promotional, marketplace, or payment functions that are supported by the relevant applications of the networked system 102.

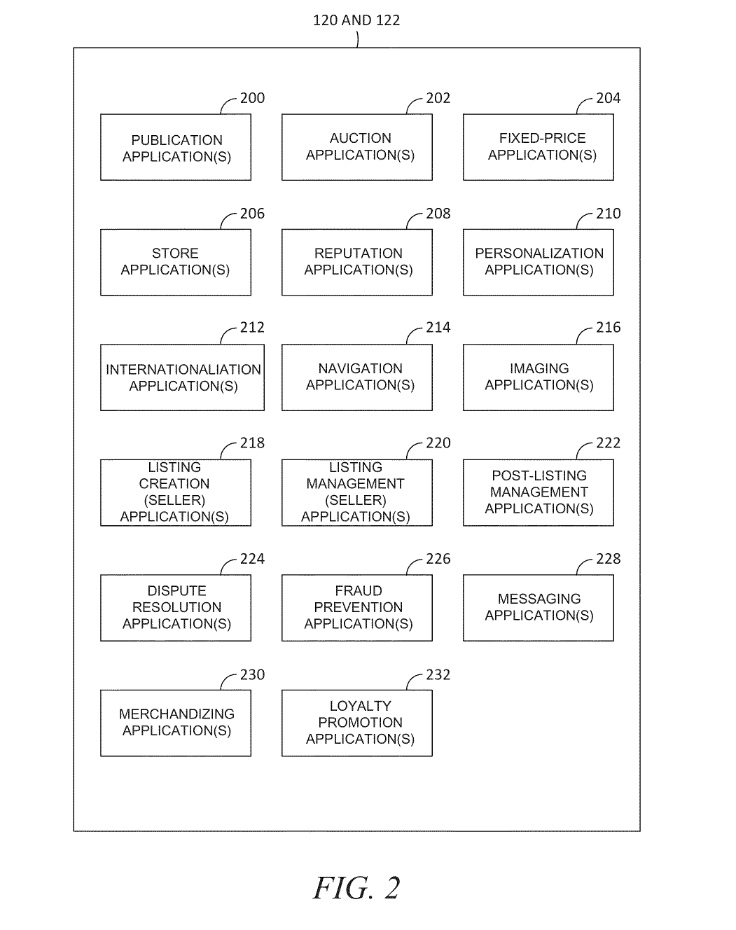

FIG. 2 is a block diagram illustrating multiple applications 120 and 122 that, in one example embodiment, are provided as part of the networked system 102. The applications 120 and 122 may be hosted on dedicated or shared server machines (not shown) that are communicatively coupled to enable communications between server machines. The applications 120 and 122 themselves are communicatively coupled (e.g., via appropriate interfaces) to each other and to various data sources, so as to allow information to be passed between the applications 120 and 122 or so as to allow the applications 120 and 122 to share and access common data. The applications 120 and 122 may furthermore access one or more databases 126 via the database servers 124.

The networked system 102 may provide a number of publishing, listing, and price-setting mechanisms whereby a seller may list (or publish information concerning) goods or services for sale, a buyer can express interest in or indicate a desire to purchase such goods or services, and a price can be set for a transaction pertaining to the goods or services. To this end, the marketplace applications 120 and 122 are shown to include at least one publication application 200 and one or more auction applications 202, which support auction-format listing and price setting mechanisms (e.g., English, Dutch, Vickrey, Chinese, Double, Reverse auctions etc.). The various auction applications 202 may also provide a number of features in support of such auction-format listings, such as a reserve price feature whereby a seller may specify a reserve price in connection with a listing and a proxy-bidding feature whereby a bidder may invoke automated proxy bidding.

A number of fixed-price applications 204 support fixed-price listing formats (e.g., the traditional classified advertisement-type listing or a catalogue listing) and buyout-type listings. Specifically, buyout-type listings (e.g., including the Buy-It-Now (BIN) technology developed by eBay Inc., of San Jose, Calif.) may be offered in conjunction with auction-format listings, and allow a buyer to purchase goods or services, which are also being offered for sale via an auction, for a fixed-price that is typically higher than the starting price of the auction.

Store applications 206 allow a seller to group listings within a “virtual” store, which may be branded and otherwise personalized by and for the seller. Such a virtual store may also offer promotions, incentives, and features that are specific and personalized to a relevant seller.

Reputation applications 208 allow users who transact, utilizing the networked system 102, to establish, build, and maintain reputations, which may be made available and published to potential trading partners. Consider that where, for example, the networked system 102 supports person-to-person trading, users may otherwise have no history or other reference information whereby the trustworthiness and credibility of potential trading partners may be assessed. The reputation applications 208 allow a user (for example, through feedback provided by other transaction partners) to establish a reputation within the networked system 102 over time. Other potential trading partners may then reference such a reputation for the purposes of assessing credibility and trustworthiness.

Personalization applications 210 allow users of the networked system 102 to personalize various aspects of their interactions with the networked system 102. For example a user may, utilizing an appropriate personalization application 210, create a personalized reference page at which information regarding transactions to which the user is (or has been) a party may be viewed. Further, a personalization application 210 may enable a user to personalize listings and other aspects of their interactions with the networked system 102 and other parties.

The networked system 102 may support a number of marketplaces that are customized, for example, for specific geographic regions. A version of the networked system 102 may be customized for the United Kingdom, whereas another version of the networked system 102 may be customized for the United States. Each of these versions may operate as an independent marketplace or may be customized (or internationalized) presentations of a common underlying marketplace. The networked system 102 may accordingly include a number of internationalization applications 212 that customize information (and/or the presentation of information) by the networked system 102 according to predetermined criteria (e.g., geographic, demographic, or marketplace criteria). For example, the internationalization applications 212 may be used to support the customization of information for a number of regional websites that are operated by the networked system 102 and that are accessible via respective web servers 116.

Navigation of the networked system 102 may be facilitated by one or more navigation applications 214. For example, a search application (as an example of a navigation application 214) may enable key word searches of listings published via the networked system 102. A browse application may allow users to browse various category, catalogues, or inventory data structures according to which listings may be classified within the networked system 102. Various other navigation applications 214 may be provided to supplement the search and browsing applications.

In order to make listings, available via the networked system 102, as visually informing and attractive as possible, the applications 120 and 122 may include one or more imaging applications 216, which users may utilize to upload images for inclusion within listings. An imaging application 216 also operates to incorporate images within viewed listings. The imaging applications 216 may also support one or more promotional features, such as image galleries that are presented to potential buyers. For example, sellers may pay an additional fee to have an image included within a gallery of images for promoted items.

Listing creation applications 218 allow sellers to conveniently author listings pertaining to goods or services that they wish to transact via the networked system 102, and listing management applications 220 allow sellers to manage such listings. Specifically, where a particular seller has authored and/or published a large number of listings, the management of such listings may present a challenge. The listing management applications 220 provide a number of features (e.g., auto-relisting, inventory level monitors, etc.) to assist the seller in managing such listings. One or more post-listing management applications 222 also assist sellers with a number of activities that typically occur post-listing. For example, upon completion of an auction facilitated by one or more auction applications 202, a seller may wish to leave feedback regarding a particular buyer. To this end, a post-listing management application 222 may provide an interface to one or more reputation applications 208, so as to allow the seller to conveniently provide feedback regarding multiple buyers to the reputation applications 208.

Dispute resolution applications 224 provide mechanisms whereby disputes arising between transacting parties may be resolved. For example, the dispute resolution applications 224 may provide guided procedures whereby the parties are guided through a number of steps in an attempt to settle a dispute. In the event that the dispute cannot be settled via the guided procedures, the dispute may be escalated to a third party mediator or arbitrator.

A number of fraud prevention applications 226 implement fraud detection and prevention mechanisms to reduce the occurrence of fraud within the networked system 102.

Messaging applications 228 are responsible for the generation and delivery of messages to users of the networked system 102, such as, for example, messages advising users regarding the status of listings at the networked system 102 (e.g., providing “outbid” notices to bidders during an auction process or to providing promotional and merchandising information to users). Respective messaging applications 228 may utilize any one of a number of message delivery networks and platforms to deliver messages to users. For example, messaging applications 228 may deliver electronic mail (e-mail), instant message (IM), Short Message Service (SMS), text, facsimile, or voice (e.g., Voice over IP (VoIP)) messages via the wired (e.g., the Internet), Plain Old Telephone Service (POTS), or wireless (e.g., mobile, cellular, WiFi, WiMAX) networks.

Merchandising applications 230 support various merchandising functions that are made available to sellers to enable sellers to increase sales via the networked system 102. The merchandising applications 230 also operate the various merchandising features that may be invoked by sellers, and may monitor and track the success of merchandising strategies employed by sellers.

The networked system 102 itself, or one or more parties that transact via the networked system 102, may operate loyalty programs that are supported by one or more loyalty/promotions applications 232. For example, a buyer may earn loyalty or promotion points for each transaction established and/or concluded with a particular seller, and be offered a reward for which accumulated loyalty points can be redeemed.

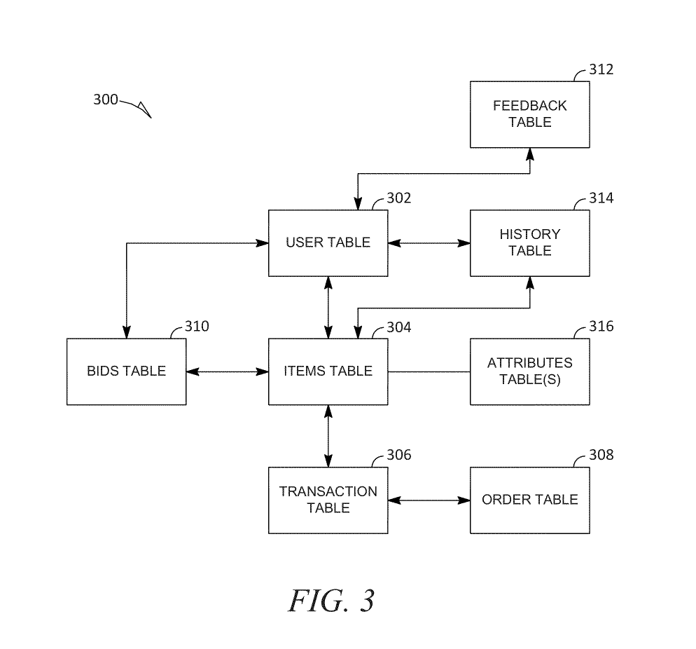

FIG. 3 is a high-level entity-relationship diagram, illustrating various tables 300 that may be maintained within the database(s) 126, and that are utilized by and support the applications 120 and 122. A user table 302 contains a record for each registered user of the networked system 102, and may include identifier, address and financial instrument information pertaining to each such registered user. A user may operate as a seller, a buyer, or both, within the networked system 102. In one example embodiment, a buyer may be a user that has accumulated value (e.g., commercial or proprietary currency), and is accordingly able to exchange the accumulated value for items that are offered for sale by the networked system 102.

The tables 300 also include an items table 304 in which are maintained item records for goods and services that are available to be, or have been, transacted via the networked system 102. Each item record within the items table 304 may furthermore be linked to one or more user records within the user table 302, so as to associate a seller and one or more actual or potential buyers with each item record.

A transaction table 306 contains a record for each transaction (e.g., a purchase or sale transaction) pertaining to items for which records exist within the items table 304.

An order table 308 is populated with order records, with each order record being associated with an order. Each order, in turn, may be associated with one or more transactions for which records exist within the transaction table 306.

Bid records within a bids table 310 each relate to a bid received at the networked system 102 in connection with an auction-format listing supported by an auction application 202. A feedback table 312 is utilized by one or more reputation applications 208, in one example embodiment, to construct and maintain reputation information concerning users. A history table 314 maintains a history of transactions to which a user has been a party. One or more attributes tables 316 record attribute information pertaining to items for which records exist within the items table 304. Considering only a single example of such an attribute, the attributes tables 316 may indicate a currency attribute associated with a particular item, with the currency attribute identifying the currency of a price for the relevant item as specified by a seller.

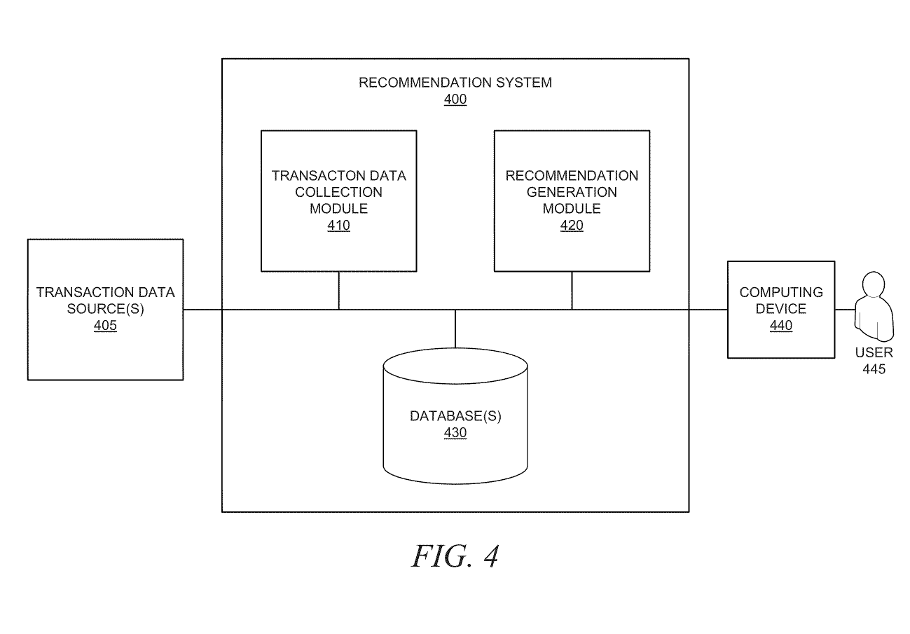

FIG. 4 is a block diagram illustrating a recommendation system 400, in accordance with some embodiments. The recommendation system 400 may comprise a transaction data collection module 410 and a recommendation generation module 420. The transaction data collection module 410 and the recommendation generation module 420 may reside on and be executable by a machine having a memory and at least one processor. The recommendation system 400 and any of its components may belong to or be operated by a first business entity.

The transaction data collection module 410 may be configured to collect transaction data corresponding to a user 445 from at least one external transaction data source 405. In some embodiments, the transaction data may comprise level-three transaction data corresponding to one or more transactions engaged in by the user 445. The transaction data may comprise at least one identification of an item purchased or sold by the user, as well as descriptive information about the item (e.g., brand, model, size, color, etc.).

The external transaction data source(s) 405 may belong to or be operated by a separate business entity from the first business entity of the recommendation system 400 and may host an account of the user 445. For example, the recommendation system 400 may belong to an e-commerce website (e.g., eBay.com), while the external transaction data source(s) 405 may belong to an e-mail service provider (e.g., Google's Gmail) or a retailer other than the e-commerce website. In some embodiments, the transaction data collection module 410 may be configured to collect the transaction data by parsing through e-mail communications belonging to an e-mail account of the user 440. In some embodiments, the e-mail communications may comprise at least one receipt for a purchased item. The collected transaction data may be stored in and subsequently retrieved from one or more databases 430.

The recommendation generation module 420 may be configured to generate a recommendation for the user 440 based on the collected transaction data. In some embodiments, the recommendation generation module 420 may also base the generation of the recommendation on information other than just the transaction data of the user 445. This other information may include, but is not limited to, an inventory of items for sale, behavior data (e.g., clickstreams) of the user 445, and demographic information of the user 445. In some embodiments, the recommendation may comprise a recommendation to buy an item. In some embodiments, the recommendation may comprise a recommendation to sell an item. It is contemplated that other types of recommendations related to an item are also within the scope of the present disclosure. Examples of other types of recommendations include, but are not limited to, recommendations to consign, borrow, lend, and trade.

In some embodiments, the transaction data collection module 410 may be configured to collect other transaction data corresponding to at least one other user from at least one external transaction data source. The other transaction data may comprise at least one identification of an item purchased by the other user(s). The external transaction data source(s) may belong to or be operated by a separate business entity from the first business entity and may host an account of the other user(s). The recommendation generation module 420 may be configured to generate the recommendation for the user 445 based on the collected transaction data corresponding to the other user(s). In some embodiments, the recommendation generation module 420 may be configured to generate the recommendation for the user based on both transaction data of the user 445 and transaction data of one or more other users.

In some embodiments, the recommendation generation module 420 may be configured to provide the recommendation to the user 445. In some embodiments, the recommendation generation module 420 may be configured to provide the recommendation to the user 445 by transmitting an e-mail message comprising the recommendation to the user 445. In some embodiments, the recommendation generation module 420 may be configured to provide the recommendation to the user 445 by presenting the recommendation to the user 445 on a website of the first business entity while the user 445 is accessing the website on using a computing device 440. The computing device 440 may include, but is not limited to, a desktop computer, a laptop computer, a smartphone, and a tablet computer. It is contemplated that other types of computing devices 440 may be used as well.

By collecting level three transaction data of users from external sources 405, the recommendation system 400 may generate recommendations based on more detailed information (e.g., product name, product brand, product model, product size, product color, etc.). The recommendation system 400 may also generate recommendations based on a greater variety of information (e.g., from the user's purchases across the entire Internet), not just from one website (e.g., the website of the recommendation system 400). The recommendation system 400 can generate a deep fingerprint of the user's needs, preferences, and history based on his or her day-to-day transactions. The use of this kind of transaction data of other users from external sources can also help the recommendation system 400 incorporate the needs, preferences, and history of the other users into the generation of the recommendations for the user 445.

The recommendation system 400 and its components may reside on or otherwise be incorporated into the networked system 102. For example, transaction data collection module 410 and recommendation generation module 420 may reside on or otherwise be incorporated into application server(s) 118, and database(s) 430 may reside on or otherwise be incorporated into database(s) 126. It is contemplated that other configurations are also within the scope of the present disclosure.

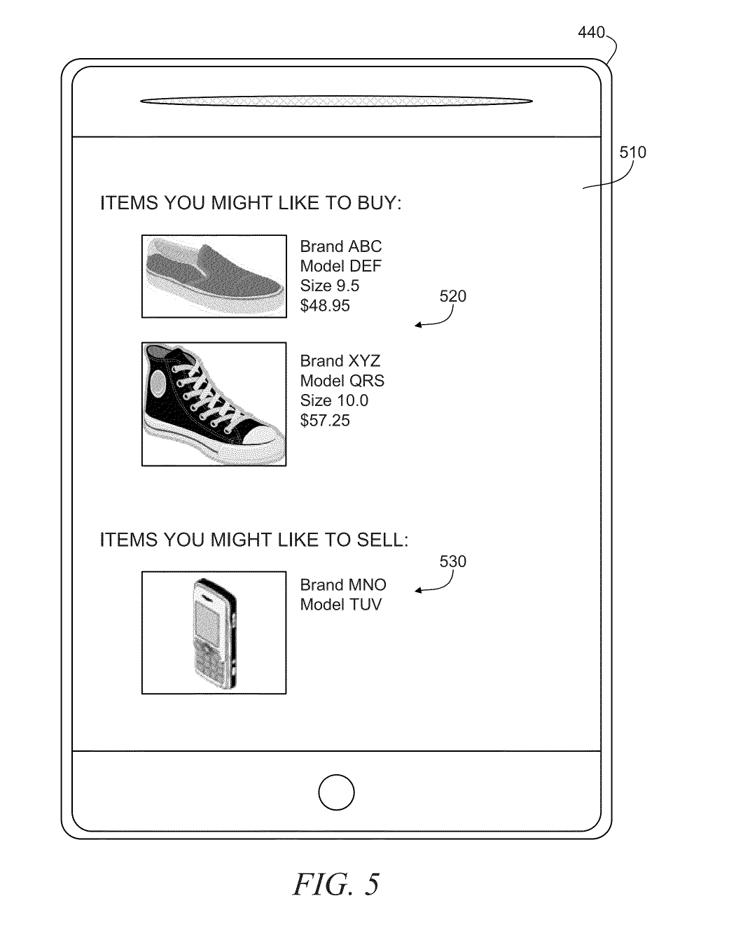

FIG. 5 illustrates generated recommendations being displayed on a user interface 510 of a computing device 440, in accordance with some embodiments. The recommendations may include, but are not limited to, recommendations 520 of items to buy and/or recommendations 530 of items to sell.

The recommendations 520 of items to buy may comprise one or more identifications of items available for the user to purchase. These recommendations may comprise an image of an item, brand information, model information, size information, color information, and/or price information, as well as other types of information regarding the item. The user's transaction data may be useful in generating these recommendations 520, as it may provide insight into what the user owns, what the user does not own, and what the user likes. Such data may also increase the quality of the recommendations 520 by adding an extra level of detail and personalization. For example, the user's transaction data may reflect that the user 445 prefers a slightly larger size of shoe (e.g., 10.0) when buying a certain brand (e.g., Brand XYZ) compared to the size of shoe (e.g., 9.5) the user 445 typically buys for other brands (e.g., Brand ABC). Therefore, the recommendation generation module 420 may identify this preference based on an analysis of the transaction data and generate the recommendations 520 accordingly.

The recommendations 530 of items to sell may comprise one or more identifications of items available for the user to sell. The recommendations 530 may comprise an image of an item, brand information, model information, size information, color information, and/or price information, as well as other types of information regarding the item. The user's transaction data may be useful in generating these recommendations 530, as it may provide insight into what the user owns, what the user does not own, and what the user likes. Such data may also increase the quality of the recommendations 520 by adding an extra level of detail and personalization. For example, the user's transaction data may reflect that the user 445 previously purchased a cell phone that is currently considered out of date or otherwise obsolete based on its model number, which may be included in the transaction data. As a result, in addition to recommending that the user 445 buy a new cell phone, the recommendation generation module 420 may recommend that the user 445 sell his old cell phone.

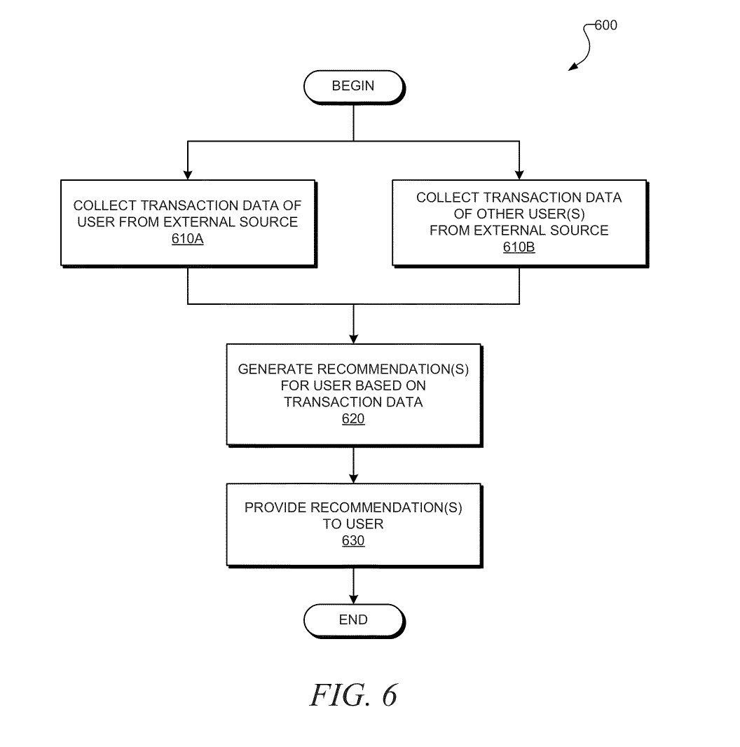

FIG. 6 is a flowchart illustrating a method 600 of generating a recommendation, in accordance with an example embodiment. It is contemplated that the operations of method 600 may be performed by a system or modules of a system (e.g., recommendation system 400 in FIG. 4). At operation 610A, transaction data corresponding to a user 445 may be collected from at least one external transaction data source 405, as previously discussed. At operation 610B, transaction data corresponding to one or more other users may be collected from at least one external transaction data source 405. It is contemplated that operation 610A and/or operation 610B may be performed. In this respect, the collected transaction data may comprise transaction data corresponding to the user 445 and/or transaction data corresponding to the other user(s). At operation 620, one or more recommendations for the user 445 may be generated based on the collected transaction data, as previously discussed. At operation 630, the generated recommendation(s) may be provided to the user 445, as previously discussed. It is contemplated that any of the other features described within the present disclosure may be incorporated into method 600.

### Modules, Components and Logic

Certain embodiments are described herein as including logic or a number of components, modules, or mechanisms. Modules may constitute either software modules (e.g., code embodied on a machine-readable medium or in a transmission signal) or hardware modules. A hardware module is a tangible unit capable of performing certain operations and may be configured or arranged in a certain manner. In example embodiments, one or more computer systems (e.g., a standalone, client, or server computer system) or one or more hardware modules of a computer system (e.g., a processor or a group of processors) may be configured by software (e.g., an application or application portion) as a hardware module that operates to perform certain operations as described herein.

In various embodiments, a hardware module may be implemented mechanically or electronically. For example, a hardware module may comprise dedicated circuitry or logic that is permanently configured (e.g., as a special-purpose processor, such as a field programmable gate array (FPGA) or an application-specific integrated circuit (ASIC)) to perform certain operations. A hardware module may also comprise programmable logic or circuitry (e.g., as encompassed within a general-purpose processor or other programmable processor) that is temporarily configured by software to perform certain operations. It will be appreciated that the decision to implement a hardware module mechanically, in dedicated and permanently configured circuitry, or in temporarily configured circuitry (e.g., configured by software) may be driven by cost and time considerations.

Accordingly, the term “hardware module” should be understood to encompass a tangible entity, be that an entity that is physically constructed, permanently configured (e.g., hardwired) or temporarily configured (e.g., programmed) to operate in a certain manner and/or to perform certain operations described herein. Considering embodiments in which hardware modules are temporarily configured (e.g., programmed), each of the hardware modules need not be configured or instantiated at any one instance in time. For example, where the hardware modules comprise a general-purpose processor configured using software, the general-purpose processor may be configured as respective different hardware modules at different times. Software may accordingly configure a processor, for example, to constitute a particular hardware module at one instance of time and to constitute a different hardware module at a different instance of time.

Hardware modules can provide information to, and receive information from, other hardware modules. Accordingly, the described hardware modules may be regarded as being communicatively coupled. Where multiple of such hardware modules exist contemporaneously, communications may be achieved through signal transmission (e.g., over appropriate circuits and buses) that connect the hardware modules. In embodiments in which multiple hardware modules are configured or instantiated at different times, communications between such hardware modules may be achieved, for example, through the storage and retrieval of information in memory structures to which the multiple hardware modules have access. For example, one hardware module may perform an operation and store the output of that operation in a memory device to which it is communicatively coupled. A further hardware module may then, at a later time, access the memory device to retrieve and process the stored output. Hardware modules may also initiate communications with input or output devices and can operate on a resource (e.g., a collection of information).

The various operations of example methods described herein may be performed, at least partially, by one or more processors that are temporarily configured (e.g., by software) or permanently configured to perform the relevant operations. Whether temporarily or permanently configured, such processors may constitute processor-implemented modules that operate to perform one or more operations or functions. The modules referred to herein may, in some example embodiments, comprise processor-implemented modules.

Similarly, the methods described herein may be at least partially processor-implemented. For example, at least some of the operations of a method may be performed by one or more processors or processor-implemented modules. The performance of certain of the operations may be distributed among the one or more processors, not only residing within a single machine, but deployed across a number of machines. In some example embodiments, the processor or processors may be located in a single location (e.g., within a home environment, an office environment or as a server farm), while in other embodiments the processors may be distributed across a number of locations.

The one or more processors may also operate to support performance of the relevant operations in a “cloud computing” environment or as a “software as a service” (SaaS). For example, at least some of the operations may be performed by a group of computers (as examples of machines including processors), these operations being accessible via a network (e.g., the network 104 of FIG. 1) and via one or more appropriate interfaces (e.g., APIs).

### Electronic Apparatus and System

Example embodiments may be implemented in digital electronic circuitry, or in computer hardware, firmware, software, or in combinations of them. Example embodiments may be implemented using a computer program product, e.g., a computer program tangibly embodied in an information carrier, e.g., in a machine-readable medium for execution by, or to control the operation of, data processing apparatus, e.g., a programmable processor, a computer, or multiple computers.

A computer program can be written in any form of programming language, including compiled or interpreted languages, and it can be deployed in any form, including as a stand-alone program or as a module, subroutine, or other unit suitable for use in a computing environment. A computer program can be deployed to be executed on one computer or on multiple computers at one site or distributed across multiple sites and interconnected by a communication network.

In example embodiments, operations may be performed by one or more programmable processors executing a computer program to perform functions by operating on input data and generating output. Method operations can also be performed by, and apparatus of example embodiments may be implemented as, special purpose logic circuitry (e.g., a FPGA or an ASIC).

A computing system can include clients and servers. A client and server are generally remote from each other and typically interact through a communication network. The relationship of client and server arises by virtue of computer programs running on the respective computers and having a client-server relationship to each other. In embodiments deploying a programmable computing system, it will be appreciated that both hardware and software architectures merit consideration. Specifically, it will be appreciated that the choice of whether to implement certain functionality in permanently configured hardware (e.g., an ASIC), in temporarily configured hardware (e.g., a combination of software and a programmable processor), or a combination of permanently and temporarily configured hardware may be a design choice. Below are set out hardware (e.g., machine) and software architectures that may be deployed, in various example embodiments.

### Example Machine Architecture and Machine-Readable Medium

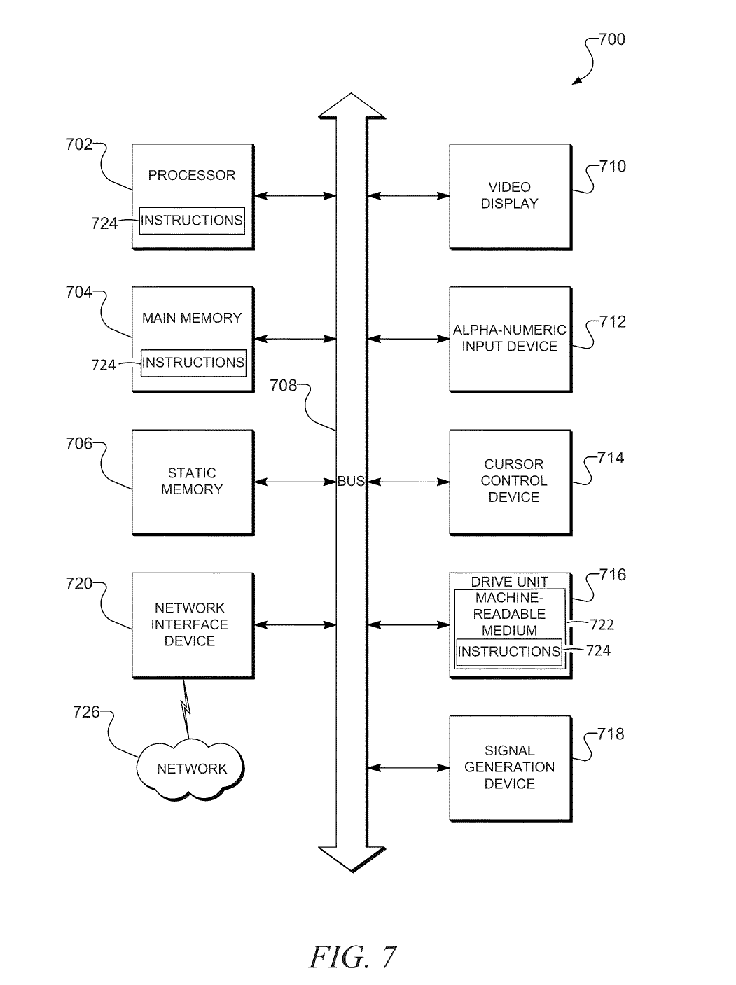

FIG. 7 is a block diagram of a machine in the example form of a computer system 700 within which instructions for causing the machine to perform any one or more of the methodologies discussed herein may be executed, in accordance with an example embodiment. In alternative embodiments, the machine operates as a standalone device or may be connected (e.g., networked) to other machines. In a networked deployment, the machine may operate in the capacity of a server or a client machine in a server-client network environment, or as a peer machine in a peer-to-peer (or distributed) network environment. The machine may be a personal computer (PC), a tablet PC, a set-top box (STB), a Personal Digital Assistant (PDA), a cellular telephone, a web appliance, a network router, switch or bridge, or any machine capable of executing instructions (sequential or otherwise) that specify actions to be taken by that machine. Further, while only a single machine is illustrated, the term “machine” shall also be taken to include any collection of machines that individually or jointly execute a set (or multiple sets) of instructions to perform any one or more of the methodologies discussed herein.

The example computer system 700 includes a processor 702 (e.g., a central processing unit (CPU), a graphics processing unit (GPU) or both), a main memory 704 and a static memory 706, which communicate with each other via a bus 708. The computer system 700 may further include a video display unit 710 (e.g., a liquid crystal display (LCD) or a cathode ray tube (CRT)). The computer system 700 also includes an alphanumeric input device 712 (e.g., a keyboard), a user interface (UI) navigation (or cursor control) device 714 (e.g., a mouse), a disk drive unit 716, a signal generation device 718 (e.g., a speaker), and a network interface device 720.

### Machine-Readable Medium

The disk drive unit 716 includes a machine-readable medium 722 on which is stored one or more sets of data structures and instructions 724 (e.g., software) embodying or utilized by any one or more of the methodologies or functions described herein. The instructions 724 may also reside, completely or at least partially, within the main memory 704 and/or within the processor 702 during execution thereof by the computer system 700, the main memory 704 and the processor 702 also constituting machine-readable media. The instructions 724 may also reside, completely or at least partially, within the static memory 706.

While the machine-readable medium 722 is shown in an example embodiment to be a single medium, the term “machine-readable medium” may include a single medium or multiple media (e.g., a centralized or distributed database, and/or associated caches and servers) that store the one or more instructions 724 or data structures. The term “machine-readable medium” shall also be taken to include any tangible medium that is capable of storing, encoding or carrying instructions for execution by the machine and that cause the machine to perform any one or more of the methodologies of the present embodiments, or that is capable of storing, encoding or carrying data structures utilized by or associated with such instructions. The term “machine-readable medium” shall accordingly be taken to include, but not be limited to, solid-state memories, and optical and magnetic media. Specific examples of machine-readable media include non-volatile memory, including by way of example semiconductor memory devices (e.g., Erasable Programmable Read-Only Memory (EPROM), Electrically Erasable Programmable Read-Only Memory (EEPROM), and flash memory devices); magnetic disks such as internal hard disks and removable disks; magneto-optical disks; and compact disc-read-only memory (CD-ROM) and digital versatile disc (or digital video disc) read-only memory (DVD-ROM) disks.

### Transmission Medium

The instructions 724 may further be transmitted or received over a communications network 726 using a transmission medium. The instructions 724 may be transmitted using the network interface device 720 and any one of a number of well-known transfer protocols (e.g., HTTP). Examples of communication networks include a LAN, a WAN, the Internet, mobile telephone networks, POTS networks, and wireless data networks (e.g., WiFi and WiMax networks). The term “transmission medium” shall be taken to include any intangible medium capable of storing, encoding, or carrying instructions for execution by the machine, and includes digital or analog communications signals or other intangible media to facilitate communication of such software.

Although an embodiment has been described with reference to specific example embodiments, it will be evident that various modifications and changes may be made to these embodiments without departing from the broader spirit and scope of the present disclosure. Accordingly, the specification and drawings are to be regarded in an illustrative rather than a restrictive sense. The accompanying drawings that form a part hereof show, by way of illustration, and not of limitation, specific embodiments in which the subject matter may be practiced. The embodiments illustrated are described in sufficient detail to enable those skilled in the art to practice the teachings disclosed herein. Other embodiments may be utilized and derived therefrom, such that structural and logical substitutions and changes may be made without departing from the scope of this disclosure. This Detailed Description, therefore, is not to be taken in a limiting sense, and the scope of various embodiments is defined only by the appended claims, along with the full range of equivalents to which such claims are entitled.

Such embodiments of the inventive subject matter may be referred to herein, individually and/or collectively, by the term “invention” merely for convenience and without intending to voluntarily limit the scope of this application to any single invention or inventive concept if more than one is in fact disclosed. Thus, although specific embodiments have been illustrated and described herein, it should be appreciated that any arrangement calculated to achieve the same purpose may be substituted for the specific embodiments shown. This disclosure is intended to cover any and all adaptations or variations of various embodiments. Combinations of the above embodiments, and other embodiments not specifically described herein, will be apparent to those of skill in the art upon reviewing the above description.

The Abstract of the Disclosure is submitted with the understanding that it will not be used to interpret or limit the scope or meaning of the claims. In addition, in the foregoing Detailed Description, it can be seen that various features are grouped together in a single embodiment for the purpose of streamlining the disclosure. This method of disclosure is not to be interpreted as reflecting an intention that the claimed embodiments require more features than are expressly recited in each claim. Rather, as the following claims reflect, inventive subject matter lies in less than all features of a single disclosed embodiment. Thus the following claims are hereby incorporated into the Detailed Description, with each claim standing on its own as a separate embodiment.

What is claimed is:

1. A system comprising:
a machine having a memory and at least one processor;
a transaction data collection module, operated by a first business entity, configured to collect transaction data corresponding to a user from at least one external source, the transaction data comprising at least one identification of an item purchased by the user, and the at least one external source belonging to a separate business entity from the first business entity and hosting an account of the user; and
a recommendation generation module, executable by the machine, configured to generate a recommendation for the user based on the collected transaction data.

2. The system of claim 1, wherein the external source is an e-mail service provider, and the transaction data collection module is configured to collect the transaction data by parsing through e-mail communications belonging to the account of the user.

3. The system of claim 2, wherein the e-mail communications comprise at least one receipt for the purchased item.

4. The system of claim 1, the external source is a retail service provider.

5. The system of claim 1, wherein the recommendation comprises a recommendation to buy an item.

6. The system of claim 1, wherein the recommendation comprises a recommendation to sell an item.

7. The system of claim 1, wherein the recommendation generation module is further configured to provide the recommendation to the user.

8. The system of claim 7, wherein the recommendation generation module is configured to provide the recommendation to the user by transmitting an e-mail message comprising the recommendation to the user.

9. The system of claim 7, wherein the recommendation generation module is configured to provide the recommendation to the user by presenting the recommendation to the user on a website of the first business entity while the user is accessing the website on a device.

10. The system of claim 1, wherein:
the transaction data collection module is further configured to collect other transaction data corresponding to at least one other user from at least one external source, the other transaction data comprising at least one identification of an item purchased by the at least one other user, and the at least one external source belonging to a separate business entity from the first business entity and hosting an account of the at least one other user; and
the recommendation generation module is further configured to generate the recommendation for the user also based on the collected other transaction data corresponding to the at least one other user.

11. A computer-implemented method comprising:
collecting, by a first business entity, transaction data corresponding to a user from at least one external source, the transaction data comprising at least one identification of an item purchased by the user, and the at least one external source belonging to a separate business entity from the first business entity and hosting an account of the user; and
generating, by a machine having a memory and at least one processor, a recommendation for the user based on the collected transaction data.

12. The method of claim 11, wherein the external source is an e-mail service provider, and collecting the transaction data comprises parsing through e-mail communications belonging to the account of the user.

13. The method of claim 11, the external source is a retail service provider.

14. The method of claim 11, wherein the recommendation comprises a recommendation to buy an item.

15. The method of claim 11, wherein the recommendation comprises a recommendation to sell an item.

16. The method of claim 11, further comprising providing the recommendation to the user.

17. The method of claim 17, wherein providing the recommendation to the user comprises transmitting an e-mail message comprising the recommendation to the user.

18. The method of claim 17, wherein providing the recommendation to the user comprises presenting the recommendation to the user on a website of the first business entity while the user is accessing the website on a device.

19. The method of claim 11, further comprising collecting, by the first business entity, other transaction data corresponding to at least one other user from at least one external source, the other transaction data comprising at least one identification of an item purchased by the at least one other user, and the at least one external source belonging to a separate business entity from the first business entity and hosting an account of the at least one other user, wherein the generated recommendation is also based on the collected other transaction data corresponding to the at least one other user.

20. A non-transitory machine-readable storage device storing a set of instructions that, when executed by at least one processor, causes the at least one processor to perform a set of operations comprising:
collecting, by a first business entity, transaction data corresponding to a user from at least one external source, the transaction data comprising at least one identification of an item purchased by the user, and the at least one external source belonging to a separate business entity from the first business entity and hosting an account of the user; and
generating, by a machine having a memory and at least one processor, a recommendation for the user based on the collected transaction data.
